(19) United States
(12) Patent Application Publication
(10) Pub. No.: US 2017/0011481 A1
(43) Pub. Date: Jan. 12, 2017

(54) DOCUMENT ANALYSIS SYSTEM, DOCUMENT ANALYSIS METHOD, AND DOCUMENT ANALYSIS PROGRAM

(71) Applicant: UBIC, Inc., Tokyo (JP)

(72) Inventors: Masahiro MORIMOTO, Tokyo (JP); Hideki TAKEDA, Tokyo (JP); Kazumi HASUKO, Tokyo (JP); Akiteru HANATANI, Tokyo (JP); Nanako YOSHIDA, Tokyo (JP)

(21) Appl. No.: 15/116,282

(22) PCT Filed: Feb. 4, 2014
(86) PCT No.: PCT/JP2014/052580

§ 371 Date: Aug. 3, 2016

(51) Int. Cl. G06Q 50/18; G06Q 30/00

(52) U.S. Cl. CPC G06Q 50/18; G06Q 30/0185

(57) ABSTRACT

Analysis of document information used for a litigation is to be facilitated. A document analysis system of the present invention includes an investigation basis database that stores a generation process model of occurrence of a predetermined action to be a cause of a litigation or fraud investigation, for each of phases classified according to development of the predetermined action, stores information related to the litigation or fraud investigation, for each of categories to which the litigation or fraud investigation belongs and the generation process model, and further stores time series information representing temporal order of the phases, and a relationship between people related to the litigation or fraud investigation; and an identifying section that analyzes the document information, based on information related to the litigation or fraud investigation, the generation process model, the time series information, and the relationship between people, and identifies a current phase.

### TECHNICAL FIELD

The present invention relates to a document analysis system, a document analysis method, and a document analysis program.

### BACKGROUND ART

Conventionally, for the cases of occurrence of a crime or a legal dispute related to computers, such as an unauthorized access and classified information leakage, equipment required to find the cause of the crime and dispute and required for investigation, and means and technologies for collecting and analyzing data and electronic records and clarifying their legal admissibility and competence of evidence have been proposed.

Particularly, civil litigation in the United States requires eDiscovery (electronic discovery) and the like. All the plaintiffs and defendants of the litigation are responsible for submitting related digital information as evidence. Consequently, digital information stored in computers and servers is required to be submitted as evidence.

According to rapid development and proliferation of IT, most of information has been created using computers in today's business. Thus, even an identical company is inundated with much digital information.

Consequently, in a process of performing preparation work for submitting evidentiary materials to a court, even errors of including classified digital information that is not necessarily related to the litigation tend to occur. Furthermore, submission of classified document information unrelated to the litigation is a problem.

In recent years, techniques pertaining to document information in forensic systems have been proposed in the following Patent Literatures 1 to 3. Patent Literature 1 discloses a forensic system that designates a specific person from among at least one or more users included in user information, extracts only digital document information accessed by the designated specific person on the basis of access history information on the specific person, sets supplementary information indicating whether each document file in the extracted digital document information relates to a litigation or not, and outputs a document file related to the litigation on the basis of the supplementary information.

Furthermore, Patent Literature 2 discloses a forensic system that displays recorded digital information, sets user identification information, for each of document files, the user identification information indicating which user the files are related to among the users included in the user information, performs setting so as to store the set user identification information in a storage, designates at least one user, retrieves a document file where the user identification information corresponding to the designated user is set, sets supplementary information indicating whether the retrieved document file is related to a litigation or not through a display unit, and outputs the document file related to the litigation.

Moreover, Patent Literature 3 accepts designation of at least one document file included in digital document information, accepts designation on which language the designated document file is to be translated into, translates the document file whose designation is accepted into the language whose designation is accepted, extracts a common document file indicating the same content as that of the designated document file from the digital document information recorded in the recording unit, generates translation-related information indicating that the extracted common document file has been translated by quoting translation content of the translated document file, and outputs the document file related to the litigation on the basis of the translation-related information.

### CITATION LIST

### Patent Literature

Patent Literature 1: Japanese Patent Application Laid-Open No. 2011-209930

Patent Literature 2: Japanese Patent Application Laid-Open No. 2011-209931

Patent Literature 3: Japanese Patent Application Laid-Open No. 2012-32859

### SUMMARY OF INVENTION

### Technical Problem

However, for example, the forensic systems such as of Patent Literatures 1 to 3 collect enormous amounts of document information on users having used multiple computers and servers.

Work of classifying whether such enormous amounts of digitized document information is appropriate as evidentiary materials for a litigation or not requires a user called a reviewer to visually verify and classify the document information on a piece-by-piece basis, which causes a problem of causing enormous efforts and costs.

The present invention has an object to provide a document analysis system, a document analysis method and a document analysis program for facilitating analysis of document information used for a litigation.

### Solution to Problem

A document analysis system of the present invention is a document analysis system that obtains information recorded in a predetermined computer or server, and analyzes document information including multiple documents included in the obtained information, including: an investigation basis database that stores a generation process model of occurrence of a predetermined action to be a cause of a litigation or fraud investigation, for each of phases classified according to development of the predetermined action, stores information related to the litigation or fraud investigation, for each of categories to which the litigation or fraud investigation belongs and the generation process model, and further stores time series information representing temporal order of the phases, and a relationship between people related to the litigation or fraud investigation; and an identifying section that analyzes the document information, based on the information related to the litigation or fraud investigation, the generation process model, the time series information, and the relationship between people, and identifies a current phase.

In the document analysis system of the present invention, the relationship between people is obtained by analyzing content of communication data or domain information that is transmitted and received between terminals and is associated with each of the people and evaluating the relationship between the content of the communication data or domain information and the information related to the litigation or fraud investigation using a result of the analysis.

The document analysis system of the present invention further includes an investigation category input accepting unit that accepts input of a category of the litigation or fraud investigation; and an investigation type determiner that determines an investigation category that is a target of an investigation, based on the category accepted by the investigation category input accepting unit, and extracts a required type of information from the investigation basis database.

The document analysis system of the present invention further includes an information extractor that extracts a keyword and/or text included in the document information, as information related to the litigation or fraud investigation, from the document information.

The document analysis system of the present invention further includes a searcher that searches the documents for the keyword and/or text.

The document analysis system of the present invention further includes an automatic classification symbol assigner that automatically assigns a classification symbol to each of the documents, wherein the keyword and/or text is used to assign the classification symbol.

A document analysis system of the present invention is a document analysis method that obtains information recorded in a predetermined computer or server, and analyzes document information including multiple documents included in the obtained information, including an identification step of referring to an investigation basis database that stores a generation process model of occurrence of a predetermined action to be a cause of a litigation or fraud investigation, for each of phases classified according to development of the predetermined action, stores information related to the litigation or fraud investigation, for each of categories to which the litigation or fraud investigation belongs and the generation process model, and further stores time series information representing temporal order of the phases, and a relationship between people related to the litigation or fraud investigation, and of analyzing the document information, based on information related to the litigation or fraud investigation, the generation process model, the time series information, and the relationship between people, to identify a current phase.

A document analysis program of the present invention is a document analysis program that obtains information recorded in a predetermined computer or server, and analyzes document information including multiple documents included in the obtained information, causing a computer to achieve an identification function of referring to an investigation basis database that stores a generation process model of occurrence of a predetermined action to be a cause of a litigation or fraud investigation, for each of phases classified according to development of the predetermined action, stores information related to the litigation or fraud investigation, for each of categories to which the litigation or fraud investigation belongs and the generation process model, and further stores time series information representing temporal order of the phases, and a relationship between people related to the litigation or fraud investigation, and of analyzing the document information, based on information related to the litigation or fraud investigation, the generation process model, the time series information, and the relationship between people, to identify a current phase.

### Advantageous Effects of Invention

The document analysis system, the document analysis method and the document analysis program of the present invention can facilitate analysis of document information used for a litigation.

### BRIEF DESCRIPTION OF DRAWINGS

FIG. 1 is a block diagram showing a main configuration of a document analysis system according to an embodiment of the present invention.

FIG. 2 is a table showing the tendency with regard to each phase in a manner viewable at a glance.

FIG. 3 is a table showing behavior and topic with regard to each phase in a manner viewable at a glance.

FIG. 4(a) is a schematic diagram showing that a process of occurrence of the predetermined action is modeled as the generation process model on a phase-by-phase basis. FIG. 4(b) is a schematic diagram showing that information related to the litigation or fraud investigation is stored with for each category to which the litigation or fraud investigation belongs and for each of the generation process models.

FIG. 5 is a schematic diagram of an overview of the operation of the document analysis system according to the embodiment of the present invention.

FIG. 6 is a detailed configuration diagram of the document analysis system according to the embodiment of the present invention.

FIG. 7 is a chart showing a flow of processes in a document analysis method according to the embodiment of the present invention.

FIG. 8 is a chart showing a flow of detailed processes in the document analysis method according to the embodiment of the present invention.

FIG. 9 is a chart showing a flow of investigation and classification processes according to investigation types in the document analysis method according to the embodiment of the present invention.

FIG. 10 is a chart showing a flow of predictive coding according to investigation types in the document analysis method of the present invention.

FIG. 11 is a chart showing a flow of processes on a stage-by-stage basis according to the embodiment.

FIG. 12 is a chart showing a processing flow of a keyword database according to the embodiment.

FIG. 13 is a chart showing a processing flow of a related term database according to this embodiment.

FIG. 14 is a chart showing a processing flow of a first automatic classifier according to this embodiment.

FIG. 15 is a chart showing a processing flow of a second automatic classifier according to this embodiment.

FIG. 16 is a chart showing a processing flow of a classification symbol accepting and assigning unit according to this embodiment.

FIG. 17 is a graph showing an analysis result in the document analyzer according to this embodiment.

FIG. 18 is a chart showing a processing flow of a third automatic classifier according to one example of this embodiment.

FIG. 19 is a chart showing a processing flow of a third automatic classifier according to another example of this embodiment.

FIG. 20 is a chart showing a processing flow of a quality inspector according to this embodiment.

FIG. 21 shows a document display screen according to this embodiment.

### DESCRIPTION OF EMBODIMENTS

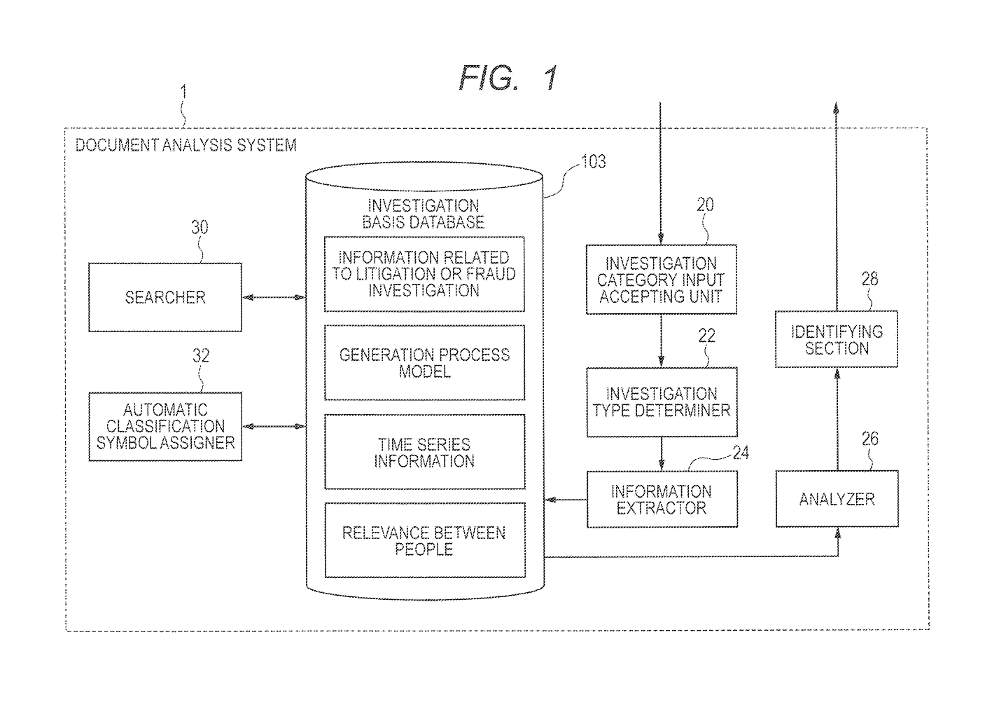

FIG. 1 is a block diagram showing a main configuration of a document analysis system 1 according to an embodiment of the present invention. The document analysis system 1 is a system that obtains information recorded in predetermined computers and servers, and analyzes document information including multiple documents included in the obtained information. As shown in FIG. 1, the document analysis system 1 includes an investigation category input accepting unit 20, an investigation type determiner 22, an information extractor 24, an investigation basis database 103, an analyzer 26, an identifying section 28, a searcher 30, and an automatic classification symbol assigner 32.

The investigation category input accepting unit 20 accepts an input of a category of a litigation or fraud investigation by a user. When the category is input, the investigation category input accepting unit 20 outputs the category to the investigation type determiner 22. Here, the category of the litigation or fraud investigation represents the characteristics of a case pertaining to the litigation or fraud investigation. For example, the category may be antitrust, patent, The Foreign Corrupt Practices Act (FCPA), product liability (PL), information leakage, billing fraud, etc.

The investigation type determiner 22 determines the category that is a target of an investigation, on the basis of the category accepted by the investigation category input accepting unit 20, and extracts a required type of information from the investigation basis database 103. For example, in the case where the document information is any of email, presentation materials, spreadsheet materials, meeting discussion materials, a written contract, an organization chart, or a business plan, the investigation type determiner 22 outputs email as the required type of information, to the information extractor 24.

The information extractor 24 extracts multiple documents from the document information. More specifically, the information extractor 24 extracts a keyword and/or text included in the information, as information related to the litigation or fraud investigation, from the information input from the investigation type determiner 22 (e.g., email, presentation materials, spreadsheet materials, meeting discussion materials, a written contract, an organization chart, a business plan, etc.), and stores the extracted result in the investigation basis database 103.

The investigation basis database 103 stores the generation process model of occurrence of a predetermined action that is a cause of the litigation or fraud investigation, for each phase of classification, according to advancement of the action. Here, the predetermined action may be, for example, an action related to a fraud action, such as antitrust, patent, The Foreign Corrupt Practices Act, product liability, information leakage, or billing fraud (e.g., attendance to a price adjustment meeting with competitors).

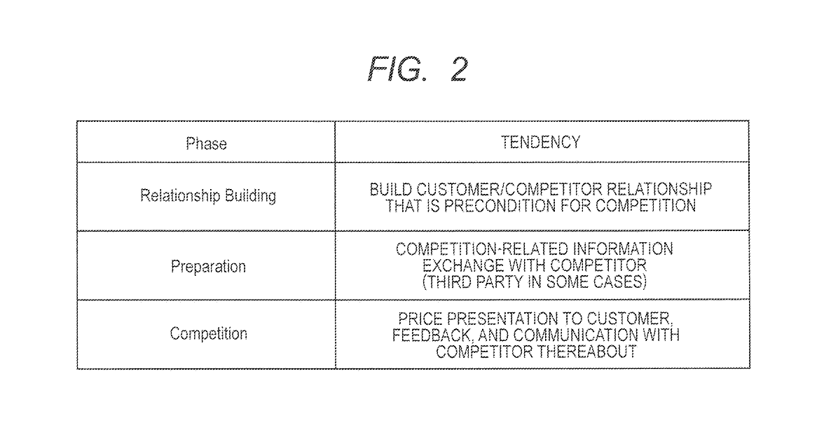

FIG. 2 is a table showing the tendency of each phase in a manner viewable at a glance. As shown in FIG. 2, the phase is an indicator that indicates each stage of advancement of the predetermined action (classification according to advancement of the predetermined action). For example, the phase of “relationship building” is a stage that serves as a precondition of the phase of competition, and is a stage of constructing a relationship with customers and competitors. A phase of “preparation” is a stage of exchanging information related to competition with competitor companies (which may be third parties). Furthermore, the phase of “competition” is a stage of proposing a price to a customer, obtaining feedback, and communicating with competitors about the feedback.

Here, in the phase of the “relationship building”, an action of “inquiry from a customer” (a predetermined action to be a cause of the litigation or fraud investigation) typically occurs. In the phase of “preparation”, an action of “obtainment of production situations of competitors” (a predetermined action to be a cause of the litigation or fraud investigation) typically tends to occur. In addition, typical actions are apparent that can be causes of a litigation and fraud investigation and associated with the respective phases.

The generation process model is a model related to a process where an action subject (an organization made up of an individual or people) approaches and performs the predetermined action according to information (e.g., a keyword extracted from the document information) related to the litigation or fraud investigation. The generation process models include, for example, a characteristic pattern model, an action pattern model, and a group pattern model.

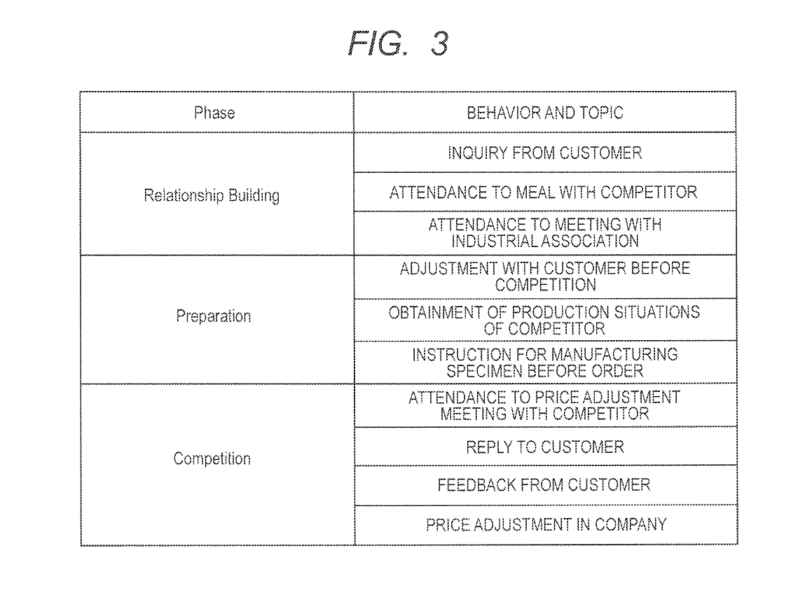

FIG. 3(a) is a schematic diagram showing that the process where the predetermined action occurs is modeled as the generation process model on a phase-by-phase basis. As described above, the investigation basis database 103 stores the generation process model on the phase-by-phase basis. For example, one generation process model is associated with the phase of the “relationship building”. Another generation process model is associated with the phase of the “preparation”. That is, the process where the predetermined action occurs is modeled as the generation process model for phase-by-phase basis.

The investigation basis database 103 further stores information related to the litigation or fraud investigation, for each category to which the litigation or fraud investigation belongs and for each of the generation process models. Here, the information related to the litigation or fraud investigation may be a keyword extracted from the document information by the information extractor 24, a combination of keywords, or meta-information. The meta-information is information indicating a predetermined attribute that the document information has. For example, in the case where the document information is email, the meta-information may be the date and times when the email was transmitted and received.

FIG. 3(b) is a schematic diagram indicating that information related to the litigation or fraud investigation is stored, for each category to which the litigation or fraud investigation belongs and for each of the generation process models. As described above, the investigation basis database 103 stores information related to the litigation or fraud investigation, for each category to which the litigation or fraud investigation belongs and for each of the generation process models. For example, information related to the litigation or fraud investigation is stored in the investigation basis database 103, for the category “antitrust” and one generation process model.

The investigation basis database 103 further stores time series information. The time series information is information indicating temporal order of the phase. According to the example shown in FIG. 2, the time series information may be information indicating a series of transitions where the phase of “relationship building” transitions to the phase of “preparation” and then develops to the phase of “competition”.

Furthermore, the investigation basis database 103 further stores the relationship between people (characteristics of a human network) related to the litigation or fraud investigation. The relationship between people is obtained by analyzing the content of communication data or domain information that is transmitted and received between terminals and is associated with each of the people and evaluating the relationship between the content of the communication data or domain information and the information related to the litigation or fraud investigation using the analyzed result.

Here, the communication data may be data including information indicating that the communication data has been transmitted from one person to another person (e.g., email, a telephone call log, an access log to a social network service, domain information representing identification of individual computers or servers, etc.). The communication data may include information for identifying a unit of an organization to which the one person belongs (e.g., subsection, section, division, company, etc.), and information for identifying a unit of an organization to which the other person belongs (e.g., subsection, section, division, company, etc.).

That is, the relationship between people indicates how much the information related to the litigation or fraud investigation has been exchanged between one person and another person, how important the information related to the litigation or fraud investigation has been exchanged or the like, on the basis of the result of analysis of the communication data.

More specifically, it is analyzed whether text related to the litigation or fraud investigation is included in the content of the communication data or not using the text mining method, image recognition method or the speech recognition method. The relevance between the communication data, having been analyzed that the data includes the text, and the litigation or fraud investigation is evaluated. For example, the degree of relevance of the content of the communication data to the litigation or fraud investigation is evaluated, and assigned as code to the communication data, the code being information on association of relevance to the litigation or fraud investigation. The automatic code assigning process is executed using the communication data assigned, as code, the information on association of relevance to the litigation or fraud investigation, thereby evaluating whether or not the communication data transmitted from the one person to the other person is related to the litigation or fraud investigation and the like. On the basis of the evaluation result, the relationship between people is obtained.

The analyzer 26 analyzes the document information on the basis of the information related to the litigation or fraud investigation, the generation process model, the time series information, and the relationship between people. More specifically, the analyzer 26 reads the information related to the litigation or fraud investigation, the generation process model, the time series information, and the relationship between people, from the investigation basis database 103, and applies morphological analysis and keyword analysis to investigation target data, thereby extracting the action that falls into the predetermined action. The analyzer 26 outputs the analyzed result (the obtained keyword or the extracted predetermined action) to the calculator 28.

The identifying section 28 identifies the current phase from the analyzed result. For example, when the keyword “inquiry from a customer” or the predetermined action is extracted, the identifying section 28 identifies that the current phase that corresponds to the keyword or the predetermined action is currently the phase of “relationship building”.

The searcher 30 searches the document information for the keyword or related term recorded in the database. That is, the searcher 30 searches the multiple documents for the keyword (word such as “infringement” or “litigation”) and/or text.

The automatic classification symbol assigner 32 automatically assigns each of the documents a classification symbol. At this time, the keyword and/or text are used to assign the classification symbol.

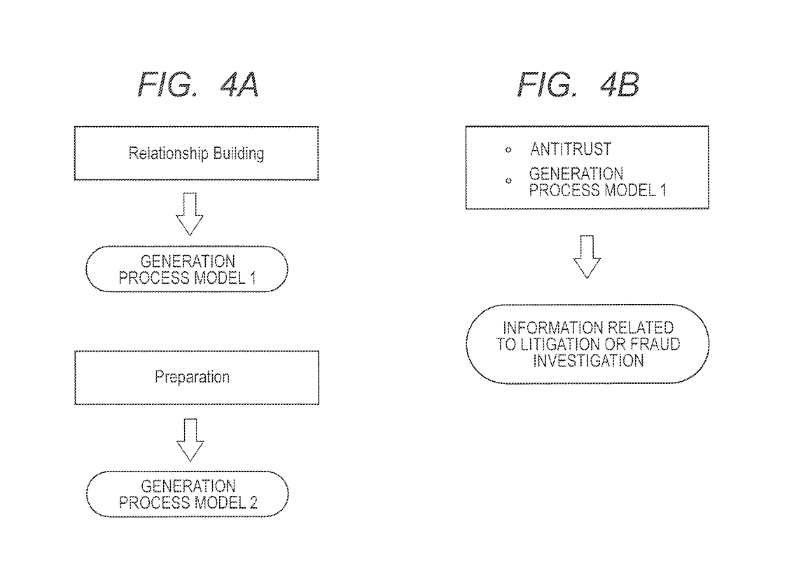

FIG. 4 is a schematic diagram of an overview of the operation of the document analysis system 1. As shown in FIG. 4, morphological analysis and keyword analysis are applied to the document information 2 as an analysis target (e.g., any document, such as of email) to thereby extract the keyword 3 (indicating the predetermined action) indicating the behavior by the action subject, and the current phase is identified on the basis of the extracted keyword 3. The identified current phase may be output (reported) to the outside in a form allowing the user to grasp the phase.

As described above, the document analysis system 1 can identify the phase of the fraud action, such as antitrust, patent, The Foreign Corrupt Practices Act, product liability, information leakage or billing fraud, for example.

Consequently, the document analysis system 1 can facilitate analysis of the document information used for a litigation.

Subsequently, the details of the document analysis system of the present invention are specifically described with reference to the drawings. The example described below is an exemplary one. The technique is not limited to this example.

FIG. 5 shows a detailed configuration example of the document analysis system according to the embodiment of the present invention.

As shown in FIG. 5, the document analysis system 1 according to this embodiment can include a data storage 100 that stores information and data. The data storage 100 stores, in a digital information storing area 101, digital information obtained from multiple computers or servers to analyze a litigation or fraud investigation.

The data storage 100 stores, for example: an investigation basis database 103 that stores a category attribute that indicates the corresponding category among litigation cases including antitrust, patent, FCPA, PL, or fraud investigations including information leakage and billing fraud, and a company name, a person in charge, a custodian, and the configuration of a research or classification input screen; a keyword database 104 where a specific classification symbol of the document included in the obtained digital information, the keyword closely related to the specific classification symbol, and keyword correspondence information that indicates the correspondence relationship between the specific classification symbol and the keyword are registered; a related term database 105 where a predetermined classification symbol, a related term including a word having a high appearance frequency in text assigned the predetermined classification symbol, and related term correspondence information that indicates the correspondence relationship between the predetermined classification symbol and the related term are registered; and a score calculation database 106 where the weight for a word included in the text to calculate the score indicating the strength of connection between the text and the classification symbol is registered.

As described above, the investigation basis database 103 stores the generation process model of occurrence of a predetermined action that is a cause of the litigation or fraud investigation, on a phase-by-phase basis for classification, according to advancement of the action. The investigation basis database 103 also stores time series information that represents the temporal order of the phases, and the relationship between people (characteristics of a human network) related to the litigation or fraud investigation.

Furthermore, the data storage 100 stores a report creation database 107 where the category, the custodian, and the form of a report defined according to the content of classification work are registered. As shown in FIG. 5, the data storage 100 may be provided in the document analysis system 1, or provided outside of the document analysis system 1 as a separate storage apparatus.

The document analysis system 1 according to the embodiment of the present invention includes a database manager 109 that manages update of the content of data in the investigation basis database 103, the keyword database 104, the related term database 105, the score calculation database 106, and the report creation database 107.

The database manager 109 can be connected to an information storage device 902 via a dedicated connection line or an Internet line 901. The database manager 109 can then update the content of data in the investigation basis database 103, the keyword database 104, the related term database 105, the score calculation database 106, and the report creation database 107, on the basis of the content of data stored in the information storage device 902.

As described above, the document analysis system 1 according to the embodiment of the present invention includes the investigation category input accepting unit 20, the investigation type determiner 22, the information extractor 24, the analyzer 26, the identifying section 28, and the searcher 30. The automatic classification symbol assigner 32 is implemented as a first automatic classifier 201, a second automatic classifier, and a third automatic classifier 401.

The document analysis system 1 according to the embodiment of the present invention may include: a score calculator 116 that calculates the score representing the strength of connection between the document and the classification symbol; the first automatic classifier 201 that causes the searcher 30 to search for the keyword recorded in the keyword database 104, extracts a document including the keyword from the document information, and automatically assigns a specific classification symbol to the extracted document on the basis of the keyword correspondence information; and the second automatic classifier 301 that extracts, from the document information, the document including the related term recorded in the related term database, calculates the score on the basis of the evaluated values of the related terms and the number of related terms included in the extracted document, and automatically assigns a predetermined classification symbol to the document having the score exceeding a certain value, on the basis of the score and the related term correspondence information.

The document analysis system 1 according to an embodiment may further include: a document display unit 130 that displays multiple documents extracted from the document information on the screen; a classification symbol accepting and assigning unit 131 that accepts the classification symbol assigned by a user to the documents to which the classification symbol extracted from the document information is not assigned, on the basis of the relevance to a litigation, and assigns the classification symbol; a document analyzer 118 that analyzes the document assigned the classification symbol by the classification symbol accepting and assigning unit 131; and a third automatic classifier 401 that automatically assigns the classification symbol to the multiple documents extracted from the document information, on the basis of the analysis result obtained by the document analyzer 118 analyzing the document having been assigned the classification symbol by the classification symbol accepting and assigning unit 131.

The document analysis system 1 according to an embodiment of the present invention may further include a language determiner 120 that determines the type of language of the extracted document, and a translator 122 that translates the extracted document upon acceptance of designation by the user or automatically. The delimited unit of the language in the language determiner 120 is set smaller than one sentence so as to support multiple languages in one sentence. Furthermore, a process of excluding the header of HTML and the like from the target of translation may be performed.

The document analysis system 1 according to an embodiment of the present invention may further include a tendency information generator 124 that generates tendency information that represents the degree of similarity to the document assigned the classification symbol of each document on the basis of the types of words, the number of appearances, and the evaluated values of the words included in each document, so as to perform analysis by the document analyzer 118.

The document analysis system 1 according to an embodiment of the present invention may further include a quality inspector 501 that compares the classification symbol accepted by the classification symbol accepting and assigning unit 131 with the classification symbol assigned according to the tendency information in the document analyzer 118, and verifies the appropriateness of the classification symbol accepted by the classification symbol accepting and assigning unit 131.

Furthermore, the document analysis system 1 according to the embodiment of the present invention may include a learning unit 601 that learns the weight for each keyword or related term on the basis of the result of document analysis process.

The document analysis system 1 according to the embodiment of the present invention may include a report creator 701 for outputting the optimal investigation report in conformity with the investigation type of the litigation case or fraud investigation on the basis of the result of the document analysis process. The litigation case may be, for example, antitrust (cartel), patent, The Foreign Corrupt Practices Act (FCPA) or product liability (PL). The fraud investigation may be, for example, information leakage or billing fraud.

The document analysis system 1 according to the embodiment of the present invention may include an attorney review accepting unit 133 that accepts a review by a chief attorney at law or a chief patent attorney in order to improve the qualities of classification investigation and report.

To facilitate understanding of the document analysis system 1 according to an embodiment of the present invention, terms specific to embodiments are described as follows.

The term “classification symbol” is an identifier used to classify documents, and represents the degree of relevancy to a litigation to facilitate use for the litigation. For example, the symbol may be assigned according to the type of an evidence when document information is used as an evidence in a litigation.

The term “document” is data that includes at least one word. Examples of “documents” include email, presentation materials, spreadsheet materials, discussion materials, a written contract, an organization chart, and a business plan.

The term “word” a unit of the minimum character string having meaning. For example, the text “the document is data that includes at least one word” includes words “document”, “one”, “at least”, “word”, “includes”, “data”, and “is”.

The term “keyword” is a character string aggregate that has a certain meaning in a certain language. For example, keywords may be selected from text “classify a document” to obtain “text” and “classify”. In the embodiment, keywords such as “infringement”, “litigation” and “Patent publication No. XX” are mainly selected.

In this embodiment, the keywords include morphemes.

The term “keyword correspondence information” represents the correspondence relationship between a keyword and a specific classification symbol. For example, if the classification symbol “important” representing an important document in a litigation has a close relationship with a keyword “infringer”, the “keyword correspondence information” may be information that manages the classification symbol “important” and the keyword “infringer” in association with each other.

The term “related term” is a word having an evaluated value of at least a certain value among words having a high appearance frequency common to the documents assigned a predetermined classification symbol. For example, the appearance frequency is a ratio of appearance of the related term to the total number of words appearing in one document.

The term “evaluated value” is the amount of information exerted by each word in a certain document. The “evaluated value” may be calculated with reference to the amount of transmitted information. For example, when a predetermined trade name is assigned as a classification symbol, the “related term” may indicate the name of a technical field to which the product belongs, a country where the product is sold, a trade name similar to that of the product. More specifically, the “related terms” in the case of assigning, as a classification symbol, the trade name of an apparatus to which an image coding process is applied may include “coding process”, “Japan” and “encoder”.

The term “related term correspondence information” represents the correspondence relationship between a related term and a classification symbol. For example, when a classification symbol “product A” which is a trade name related to a litigation has a related term “image coding” which is a function of the product A, the “related term correspondence information” may be information where the classification symbol “product A” and the related term “image coding” are associated with each other and managed.

The term “score” is qualitative evaluation of the strength of connection with a specific classification symbol in a certain document. In each embodiment of the present invention, for example, the score is calculated on the basis of words appearing in a document and the evaluated value of each word using the following expression (1).

[Expression 1]

Sdr=Σᵢ₌₀^{N}i*(mᵢ*wgtᵢ²)/Σᵢ₌₀^{N}*wgtᵢ² (1)

Scr: Score of document

mᵢ: Appearance frequency of i-th keyword or related term

wgtᵢ²: Weight of i-th keyword or related term

The document analysis system 1 according to an embodiment of the present invention may extract a word that frequently appears in documents having a common classification symbol assigned by the user. The tendency information which is included in each document and is on the type of the extracted word, the evaluated value of each word, and the number of appearances may be analyzed on a document-by-document basis, and a common classification symbol may be assigned to a document having the same tendency as the analyzed tendency information among documents where no classification symbol is accepted by the classification symbol accepting and assigning unit 131.

Here, the term “tendency information” represents the degree of similarity to the document assigned the classification symbol of each document, and is represented by the degree of relevancy to the predetermined classification symbol based on the type of the word included in each document, the number of appearances, and the evaluated value of the word. For example, when each document is similar to the document assigned the predetermined classification symbol in degree of relevancy with this predetermined classification symbol, the two documents have the same tendency information. Documents including words having the same evaluated value with the same number of appearance even if the types of included words are different from each other may be regarded as documents having the same tendency.

Next, a document analysis method of the present invention is described.

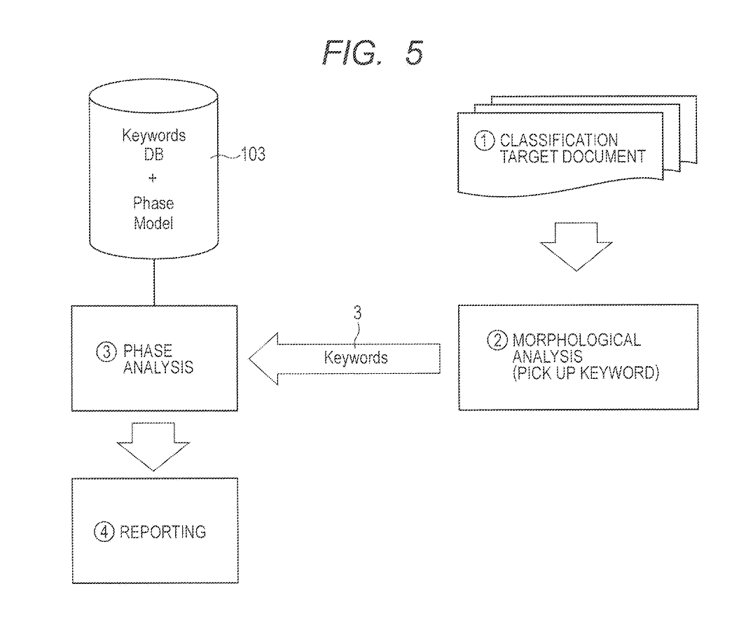

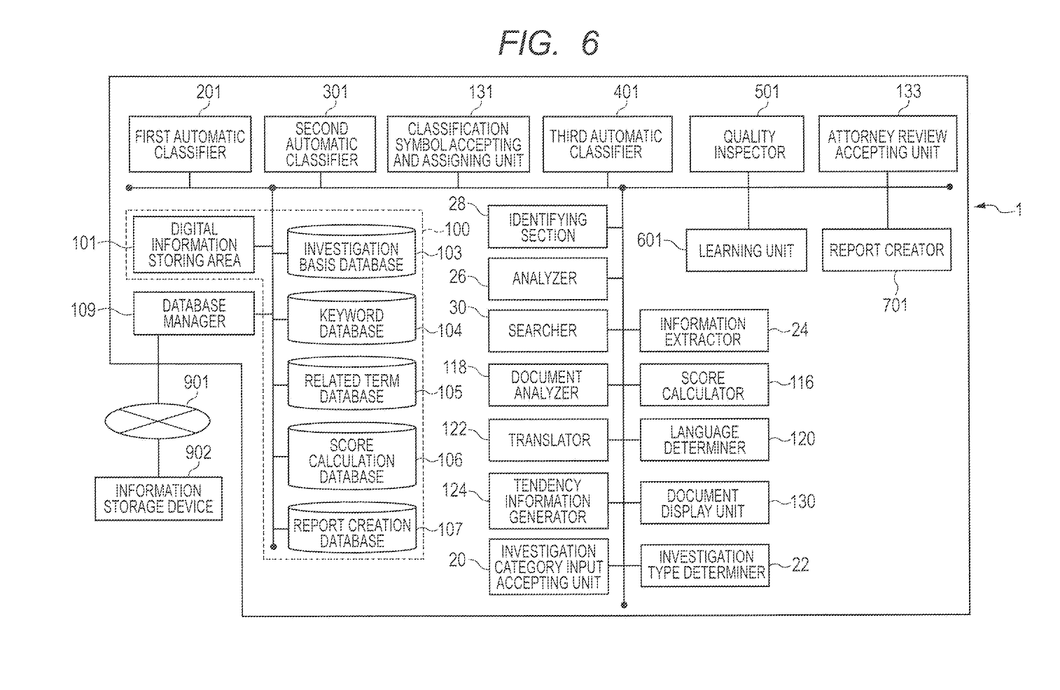

FIG. 6 is a flowchart showing a flow of processes of the document analysis method (method of controlling the document analysis system) according to the embodiment of the present invention.

First, the analyzer 26 reads the information related to the litigation or fraud investigation, the generation process model, the time series information, and the relationship between people related to the litigation or fraud investigation, from the investigation basis database 103 (step 41, hereinafter, “step” is abbreviated as “S”). Next, the analyzer 26 performs morphological analysis of the investigation target data and keyword analysis (S42), thereby extracting the behavior falling into the predetermined action (S43). The identifying section 28 then identifies the current phase from the analyzed result (S44, identification step).

Subsequently, the details of the document analysis method of the present invention are specifically described with reference to the drawings. The example described below is an exemplary one. The technique is not limited to this example.

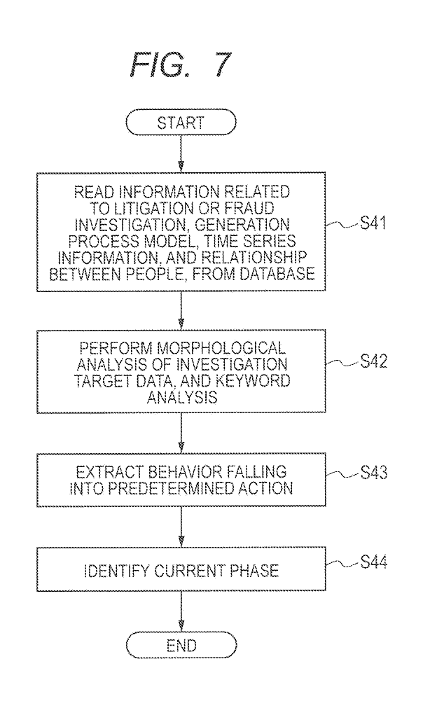

FIG. 7 shows a detailed flowchart of the document analysis method according to the embodiment of the present invention. The flow shown in FIG. 6 may be performed as processes independent of the flow shown in FIG. 7, or executed as processes internally included at any position in the flow shown in FIG. 7.

Upon acceptance of designation of an argument from the user according to display of a display screen of the display unit, the corresponding category can be identified from the litigation cases including antitrust, patent, FCPA, and PL, or fraud investigation including information leakage and billing fraud, for example (S11).

According to the identified category, the database to be used, such as the investigation basis database and the document analysis database, can be identified (S12).

In order to verify whether the database to be used is the latest or not, an information storage device that stores the latest database can be accessed. The information storage device is installed in an organization that executes classification in some cases, and is installed outside of the organization in the other cases. The cases where the information storage device is installed outside of the organization include, for example, a case where the apparatus is installed in an affiliated law firm or patent firm.

When the information storage device is accessed, authentication can be performed using an ID and a password in order to maintain security (S13).

After the authentication, access to the information storage device is allowed, the databases to be used, such as the investigation basis database and the document analysis database, can be updated to guided databases (S14).

The updated investigation basis database is searched (S15), and the company name and the names of the person in charge and custodian can be presented on the screen of the display device (S16).

When the names of the person in charge and custodian displayed on the screen of the display device are different from the names of actual person in charge and custodian, the user corrects the names of the person in charge and custodian on the screen of the display device. The document analysis system accepts an input for correction by the user, and the names of actual person in charge and custodian can be identified (S17).

Next, the digital document information can be extracted in order to execute the document analysis work (S18).

The updated keyword database, related term database and score calculation database can be searched as updated document analysis databases (S19), and the classification symbol can be assigned to the extracted document information (S20).

Furthermore, the classification symbol by the reviewer can be accepted to assign the classification symbol to the extracted document information (S21).

The database can be searched with the classification result being adopted as training data, and the classification symbol can be assigned to the extracted document information (S22).

The review by the chief attorney at law or patent attorney can be accepted (S23). Consequently, the quality of investigation can be improved.

Designation of an argument by the user can identify the category (S24), and the report creation database can be identified according to the identified category (S25). According to the identified report creation database, the form of the report can be determined, and the report can be automatically output (S26).

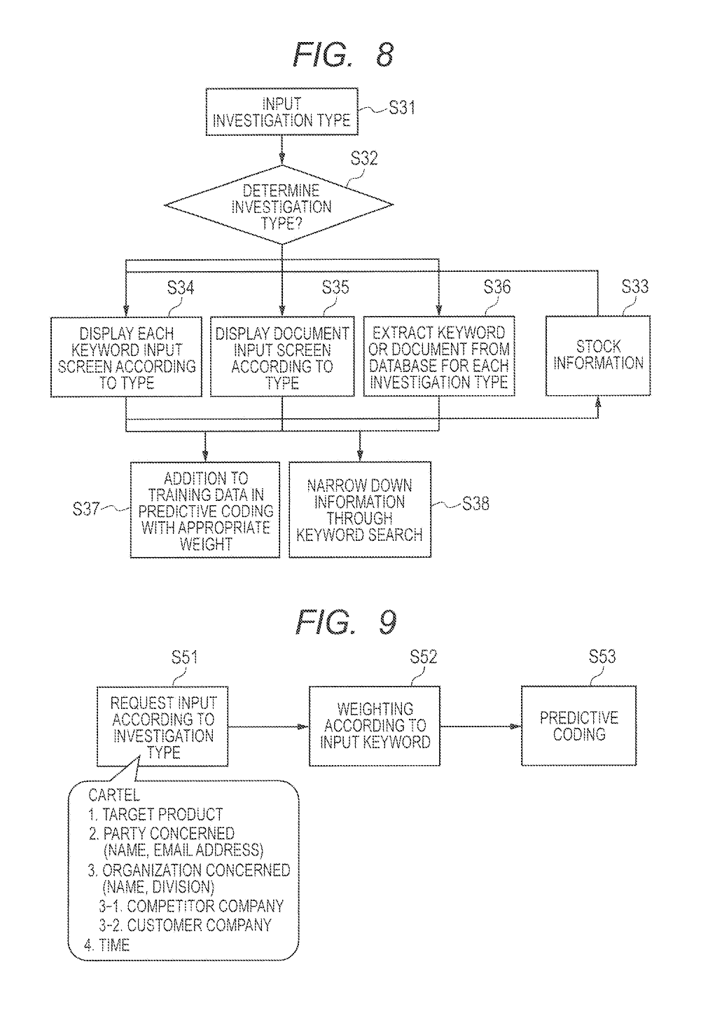

FIG. 8 is a chart showing a flow of investigation and classification processes according to investigation types in the document analysis method according to the embodiment of the present invention.

First, the investigation type can be input (S31). That is, according to the display of the display screen, the user inputs an investigation and classification work intended to be executed among litigation cases including antitrust, patent, The Foreign Corrupt Practices Act (FCPA), and product liability (PL), or fraud investigation including information leakage and billing fraud, for example. The document analysis system can accept an input of a category by the use, and identify the category that is to be an investigation target.

According to the identified category, the types of investigation and document analysis process and the type of the database to be used can be determined (S32).

According to the identified category, stock of information stored in the databases to be used, such as the investigation basis database and the document analysis database, may be accessed (S33).

According to the identified category, the investigation basis database can be accessed, and each keyword input screen according to the identified category can be displayed (S34).

According to the identified category, the investigation basis database can be accessed, and each document input screen according to the identified category can be displayed (S35).

According to the identified category, the investigation basis database can be accessed, and the keyword or document according to the identified category can be extracted (S36).

The training data of the automatic classification symbol assignment (predictive coding) can be additionally weighted by executing the aforementioned processes (S37).

The extracted document and information can be narrowed down by performing keyword search of the document analysis database (S38).

FIG. 9 is a chart showing a flow of predictive coding according to investigation types in the document analysis method according to the embodiment of the present invention.

The document analysis method according to the embodiment of the present invention, first, requests an input according to the type of the investigation from the user, and can accept the input by the user for the request. For example, in relation to antitrust law, in consideration of a cartel, the user is requested to input a target product, a party concerned (name and email address), an organization concerned (name and division) and time, and the input by the user for the request can be accepted. In addition, in relation to the organization concerned, the user is requested to input competitor companies and customer companies, and the input by the user for the request can be accepted (S51).

Next, assignment of the classification symbol can be weighted according to input keyword (S52). The predictive coding can then be performed (S53).

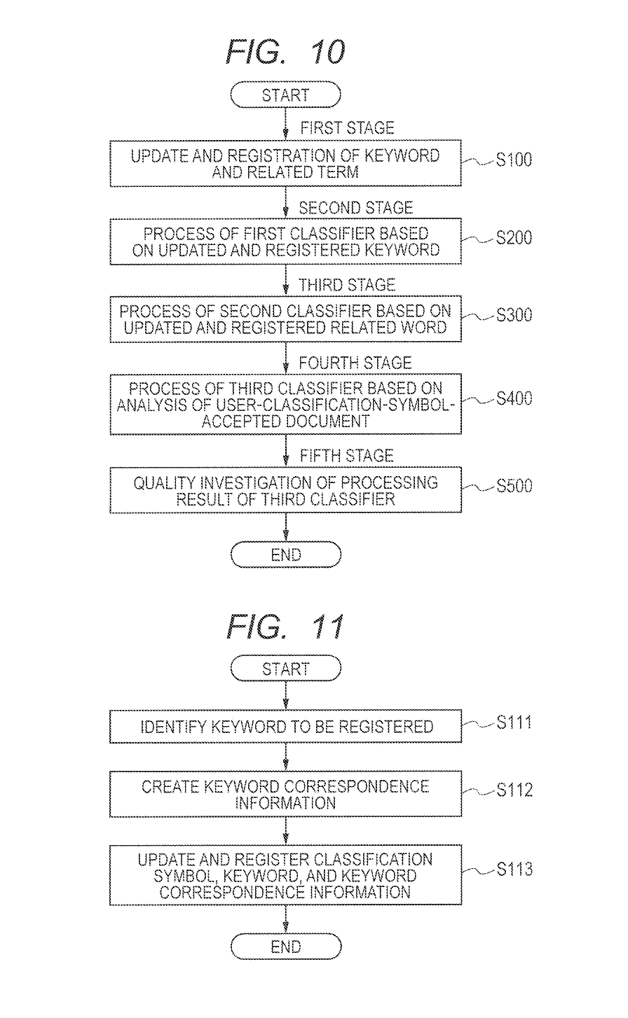

In the embodiment of the present invention, as an example, according to a flowchart as shown in FIG. 10, a registration process, a classification process and an inspection process are performed in first to fifth stages.

On the first stage, the keyword and the related term are preliminarily updated and registered using a result of a previous classification process (S100). At this time, the keyword and the related term are updated and registered together with the keyword correspondence information and the related term correspondence information which are correspondence information on the classification symbol and the keyword or the related term.

On the second stage, a first classification process is executed that extracts a document including the keyword updated and registered in the first stage from the entire document information, refers to the updated keyword correspondence information recorded in the first stage upon finding the document, and assigns the classification symbol corresponding to the keyword (S200).

On the third stage, the document including the related term updated and registered in the first stage is extracted from the document information assigned no classification symbol in the second stage, and the score of the document including the related term is calculated. A second classification process is executed that refers to the calculated score and the related term correspondence information updated and registered on the first stage and assigns the classification symbol (S300).

On the fourth stage, the classification symbol assigned by the user is accepted with respect to the document information where no classification symbol has been assigned until the third stage, and the classification symbol accepted from the user is assigned to the document information. Next, a third classification process is executed that analyzes the document information assigned the classification symbol accepted from the user, extracts the document assigned no classification symbol on the basis of the analysis result, and assigns the classification symbol to the extracted document. For example, a word frequently appearing in documents with the common classification symbol assigned by the user is extracted, the tendency information which is included in each document and is on the type of the extracted word, the evaluated value of each word, and the number of appearances may be analyzed on a document-by-document basis, and a common classification symbol is assigned to a document having the same tendency as the tendency information (S400).

On the fifth stage, the classification symbol to be assigned to the document to which the user has assigned the classification symbol is determined on the basis of the analyzed tendency information, the determined classification symbol is compared with the classification symbol assigned by the user, and the appropriateness of the classification process is verified. (S500) A learning process can be performed on the basis of the result of the document analysis process as necessary.

Here, the tendency information used in the processes in the fourth and fifth stages is of each document, represents the degree of similarity to the document assigned the classification symbol, and is based on the type of the word included in each document, the number of appearances, and the evaluated value of the word. For example, when each document is similar to the document assigned the predetermined classification symbol in degree of relevancy with this predetermined classification symbol, the two documents have the same tendency information. Documents including words having the same evaluated value with the same number of appearance even if the types of included words are different from each other may be regarded as documents having the same tendency.

Detailed processing flows in each of the first to fifth stages are described as follows.

<First Stage (S100)>

A detailed processing flow of the keyword database 104 on the first stage is described with reference to FIG. 11.

The keyword database 104 creates a table for management for each classification symbol in consideration of a result of classification of documents in previous litigations, and identifies a keyword corresponding to each classification symbol (S111). In the embodiment of the present invention, the identification may be made by analyzing the document assigned each classification symbol, using the number of appearances and evaluated value of each keyword in the document. Alternatively, a method of using the amount of transmitted information held by the keyword, or a method of manual selection by the user may be adopted.

In the embodiment of the present invention, for example, when keywords “infringement” and “patent attorney” are identified as keywords of a classification symbol “important”, keyword correspondence information indicating that the “infringement” and “patent attorney” are keywords having close relationship with the classification symbol “important” is created (S112). The identified keyword is registered in the keyword database 104. In this case, the identified keyword and the keyword correspondence information are associated with each other, and recorded in the management table of the classification symbol “important” of the keyword database 104(S113).

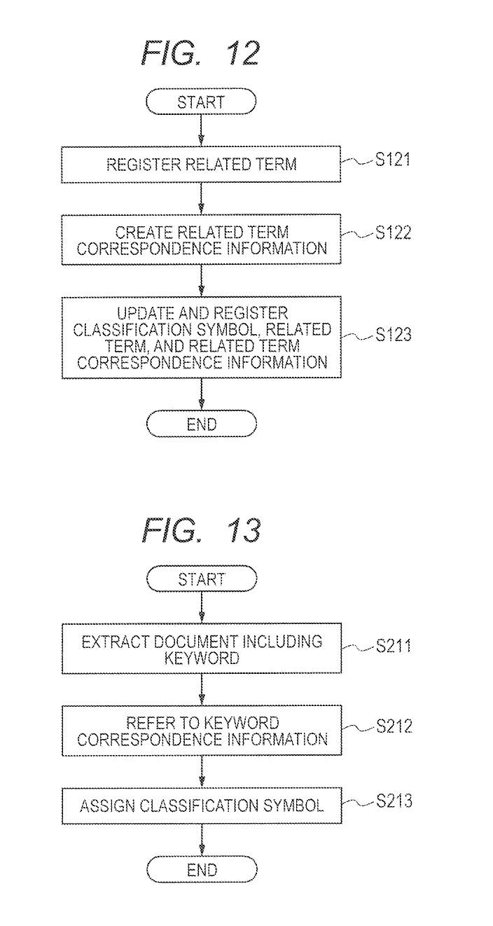

Next, a detailed processing flow of the related term database 105 is described with reference to FIG. 12. The related term database 105 creates a table for management for each classification symbol in consideration of a result of classification of documents in previous litigations, and registers a related term corresponding to each classification symbol (S121). In the embodiment of the present invention, for example, “coding process” and “product a” are registered as related terms of “product A”, and “decode” and “product b” are registered as related terms of “product B”.

The related term correspondence information indicating correspondence of the registered related terms to the classification symbols is created (S122), and recorded in each management table (S123). At this time, in the related term correspondence information, the evaluated value of each related term, and a threshold that serves as a score required to determine the classification symbol are recorded together.

Before actual classification work, the keyword and keyword correspondence information, and the related term and related term correspondence information are updated to the latest ones and registered (S113, S123).

<Second Stage (S200)>

A detailed processing flow of the first automatic classifier 201 on the second stage is described with reference to FIG. 13. In the embodiment of the present invention, in the second stage, a process of assigning the classification symbol “important” to the document is performed by the first automatic classifier 201.

The first automatic classifier 201 extracts, from the document information, a document that includes “infringement” and “patent attorney” registered in the keyword database 104 in the first stage (S100), and extracts, from the document information, the document that includes keywords “infringement” and “patent attorney” registered in the keyword database 101 (S211). With respect to the extracted document, according to the keyword correspondence information, the management table that records the keyword is referred to (S212), and the classification symbol “important” is assigned (S213).

<Third Stage (S300)>

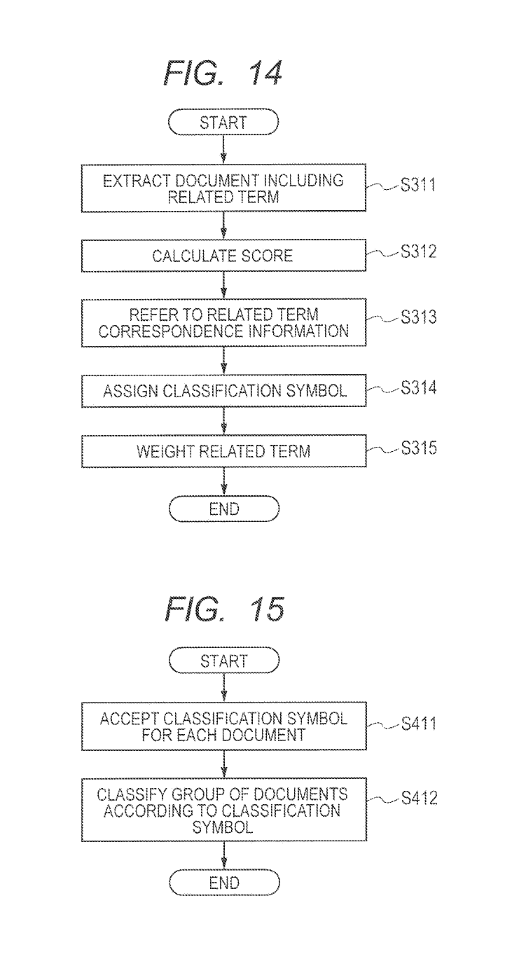

A detailed processing flow of the second automatic classifier 301 on the third stage is described with reference to FIG. 14.

In the embodiment of the present invention, the second automatic classifier 301 performs a process of assigning the classification symbols “product A” and “product B” to the document information having been assigned no classification symbol on the second stage (S200).

The second automatic classifier 301 extracts documents including the related terms “coding process”, “product a”, “decode” and “product b”, which have been recorded in the related term database 105 on the first stage, from the document information (S311). The scores of the extracted documents are calculated by the score calculator 116 using the expression (1) on the basis of the appearance frequencies and evaluated values of the recorded four related terms (S312). The score represents the degree of relevancies between each document and the classification symbols “product A” and “product B”.

When the score exceeds the threshold, the related term correspondence information is referred to (S313), and an appropriate classification symbol is assigned (S314).

For example, when the appearance frequencies of the related terms “coding process” and “product a” and the evaluated value of the related term “coding process” are high and the score representing the degree of relevancy to the classification symbol “product A” exceeds the threshold in a certain document, the document is assigned the classification symbol “product A”.

At this time, when the appearance frequency of the related term “product b” is also high and the score representing the degree of relevancy to the classification symbol “product B” exceeds the threshold, the document is assigned the classification symbol “product B” besides the classification symbol “product A”. On the contrary, when the appearance frequency of the related term “product b” is low and the score representing the degree of relevancy to the classification symbol “product B” does not exceed the threshold, the document is only assigned the classification symbol “product A”.

In the second automatic classifier 301, the evaluated value of the related term is recalculated according to the following expression (2) using the score calculated in S 432 on the fourth stage, and the evaluated value is weighted (S315).

[Expression 2]

wgt_{i,L}=\sqrt{wgt_{L-i}²+γ_{L}wgt_{i,L}²−θ}=wgt_{i,L}²+Σₗ₌₁^{L}(γₗwgt_{i,l}²−θ) (2)

wgt_{i,0}: Weight of i-th selected keyword before learning (initial value)

wgt_{i,L}: Weight of i-th selected keyword after L times of learning

Y_{L}: Learning parameter in L-th learning

θ: Threshold of learning effect

For example, when a certain number of documents that have a significantly high appearance frequency of “decode” but have a score is as low as a certain value or less occur, the evaluated value of the related term “decode” is reduced and recorded in the related term correspondence information again.

<Fourth Stage (S400)>

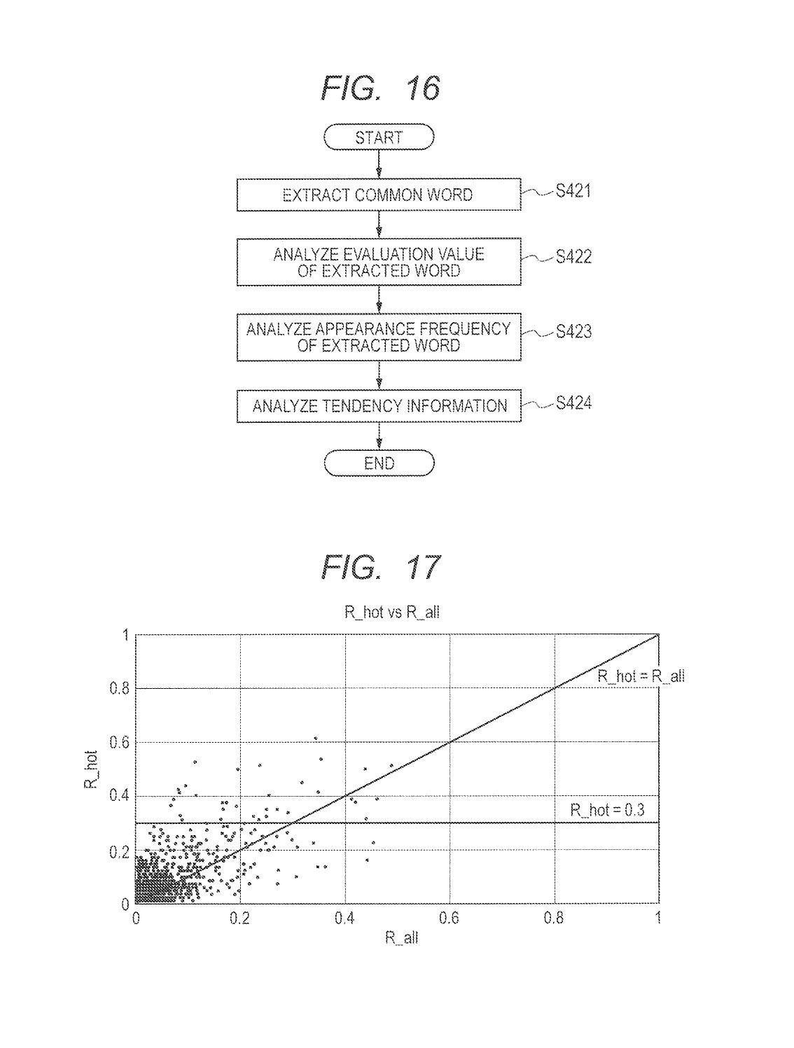

On the fourth stage, as shown in FIG. 15, assignment of the classification symbol from a reviewer to a certain ratio of pieces of document information extracted from the document information having being assigned no classification symbol until the processes of the third stage is accepted, and the accepted classification symbol is assigned to the document information. Next, as shown in FIG. 16, the document information assigned the classification symbol accepted from the reviewer is analyzed, the document information assigned no classification symbol is assigned the classification symbol on the basis of the analysis result. In the embodiment of the present invention, on the fourth stage, for example, a process of assigning the classification symbols “important”, “product A” and “product B” is executed. The fourth stage is further described as follows.

A detailed flow of the classification symbol accepting and assigning unit 131 on the fourth stage is described with reference to FIG. 15. First, the information extractor 24 randomly samples document from the document information that is to be a processing target on the fourth stage, and displays the document on the document display unit 130. In the embodiment of the present invention, documents that are 20% of document information to be processed are randomly extracted, and treated as classification targets to be classified by the reviewer. The sampling may be performed according to an extraction method that arranges the documents in an order of the creation date and time or name and selects 30% of documents from the top.

The user views a display screen 11 that is displayed on the document display unit 130 and shown in FIG. 21, and selects the classification symbol to be assigned to each document. The classification symbol accepting and assigning unit 131 accepts the classification symbol selected by the user (S411), and performs classification on the basis of the assigned classification symbol (S412).

Next, a detailed flow of the document analyzer 118 is described with reference to FIG. 16. The document analyzer 118 extracts a word frequently appearing in common to the documents classified by the classification symbol accepting and assigning unit 131, according to each classification symbol (S421). The evaluated value of the common word extracted is analyzed according to the expression (2) (S422), and the appearance frequency of the common word in the document is analyzed (S423).

Furthermore, in consideration of the results analyzed in S 422 and S 423, the tendency information on the document assigned the classification symbol “important” is analyzed (S424).

FIG. 17 is a graph of results of analysis of words frequently appearing in common to the documents assigned the classification symbol “important” in S 424.

In FIG. 17, the ordinate axis R_hot represents the ratio of documents that includes the word selected as a word associated with the classification symbol “important” and is assigned the classification symbol “important” among all the documents assigned the classification symbol “important”. The abscissa axis represents the ratio of documents that includes the word extracted in S 421 by the classification symbol accepting and assigning unit 131 among all the documents to which the user has applied the classification process.

In the embodiment of the present invention, the classification symbol accepting and assigning unit 131 extracts words plotted higher than a straight line R_hot=R_all as the common words with the classification symbol “important”.

The processes in S421 to S424 are executed also to documents assigned the classification symbols “product A” and “product B”, and the tendency information on the documents is analyzed.

Next, a detailed processing flow of the third automatic classifier 401 is described with reference to FIG. 18. The third automatic classifier 401 applies a process to documents where assignment of the classification symbol has not been accepted by the classification symbol accepting and assigning unit 131 in S411 among the processing target document information on the fourth stage. The third automatic classifier 401 extracts documents having the same tendency information as the documents that have been analyzed in S424 and assigned the classification symbols “important”, “product A” and “product B” (S431), and calculates the scores of the extracted documents on the basis of the tendency method using the expression (1) (S432). The documents extracted in S431 are assigned appropriate classification symbols on the basis of the tendency information (S433).

The third automatic classifier 401 reflects the classification result in each database using the scores calculated in S432 (S434). More specifically, a process may be performed that reduces the evaluated values of the keyword and the related term included in the document with a low score while increasing the evaluated values of the keyword and the related term included in the document with a high score.

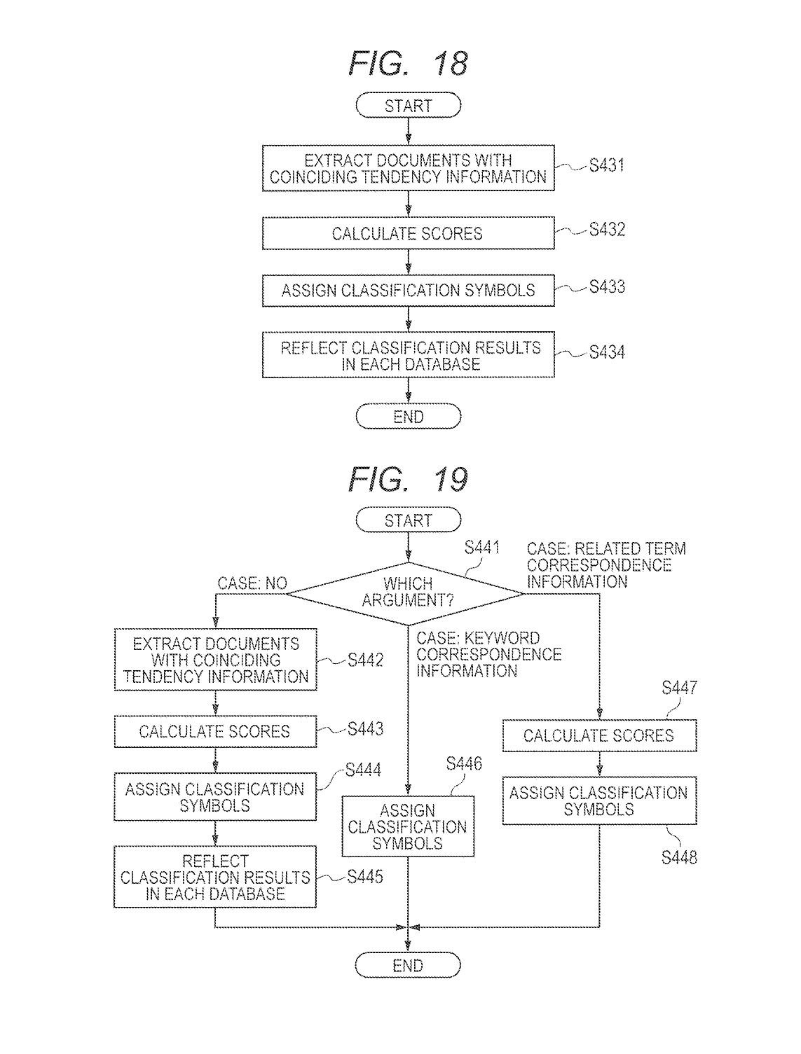

Furthermore, an example of a detailed processing flow of the third automatic classifier 401 is described with reference to FIG. 19. The third automatic classifier 401 may apply a classification process to documents where assignment of the classification symbol has not been accepted by the classification symbol accepting and assigning unit 131 in S411 in the processing target document information on the fourth stage. When no argument is provided (S441: NO), the third automatic classifier 401 extracts documents having the same tendency information as the documents that have been analyzed in S424 and assigned the classification symbol “important” (S442), and calculates the scores of the extracted documents on the basis of the tendency information using the expression (1) (S443). The documents extracted in S442 are assigned appropriate classification symbols on the basis of the tendency information (S444).

The third automatic classifier 401 reflects the classification result in each database using the scores calculated in S443 (S445). More specifically, a process is performed that reduces the evaluated values of the keyword and the related term included in the document with a low score while increasing the evaluated values of the keyword and the related term included in the document with a high score.

As described above, score calculation is performed by both the second automatic classifier 301 and the third automatic classifier 401. When the number of score calculations is high, data items for score calculation may be collectively stored in the score calculation database 106.

<Fifth Stage (S500)>

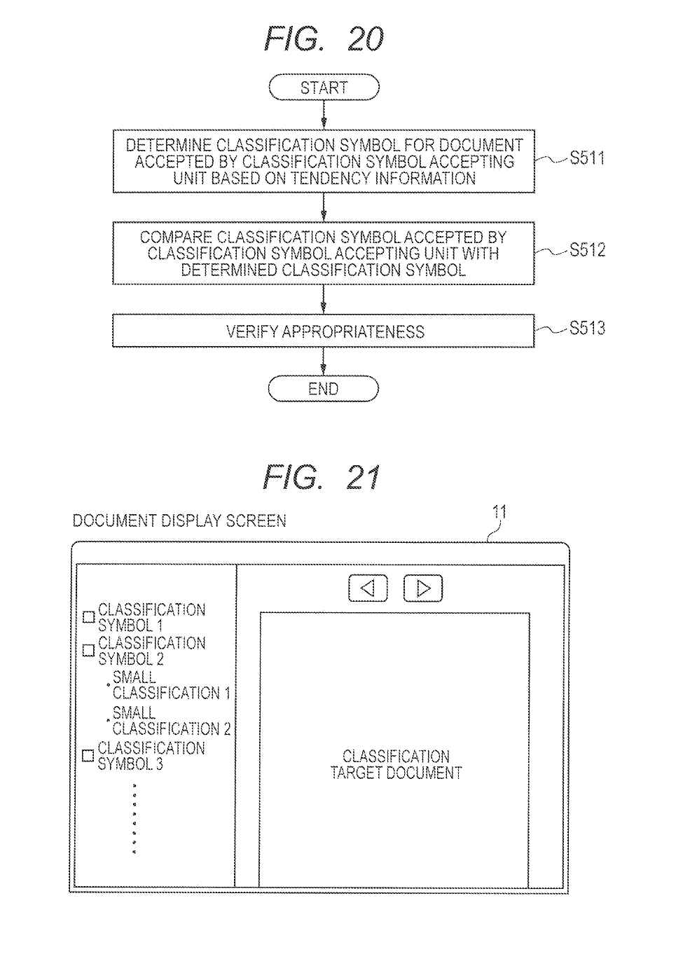

A detailed processing flow of the quality inspector 501 on the fifth stage is described with reference to FIG. 20. In the quality inspector 501, the classification symbol accepting and assigning unit 131 determines a classification symbol to be assigned to the document accepted in S411, on the basis of the tendency information analyzed by the document analyzer 118 in S424 (S511).

The classification symbol accepted by the classification symbol accepting and assigning unit 131 is compared with the classification symbol determined in S511 (S512), and the appropriateness of the classification symbol accepted in S411 is verified (S513).

The document analysis system 1 according to the embodiment of the present invention may include a learning unit 601. The learning unit 601 learns the weighting of each keyword or related term on the basis of the first to fourth processing results according to the expression (2). The learned result may be reflected in the keyword database 104, the related term database 105, or the score calculation database 106.

The document analysis system 1 according to the embodiment of the present invention may include a report creator 701 for outputting the optimal investigation report in conformity with the investigation type of a litigation case (e.g., a cartel, patent, FCPA, PL, etc. in the case of a litigation) or fraud investigation (e.g., information leakage, billing fraud, etc.) on the basis of the result of the document analysis process.

The content of investigation is different according to the investigation type.

For example, in the case of a cartel case, the points are as follows.

1. When and how a person in charge of a competitor communicates in relation to the cartel (price adjustment)?

2. Who is the party concerned and what organization the party concerned belongs?

In the case of patent infringement, the points are as follows.

1. Whether the content is the same as the technology that is a target of infringement or not?

2. Who, when and with what intention (or with no intention), infringed or not?

A document investigation report system and a document investigation report method and a document investigation report program according to other examples of the embodiment of the present invention are described below.

The document investigation report system according to the other example of the embodiment of the present invention analyzes the document having already been assigned the classification symbol, according to similar search information, and adjusts the range where the classification symbol is assigned, on the basis of the analysis result. The classification work and investigation work are performed on the basis of the adjusted range where the classification symbol is assigned, and a report is created on the basis of the results of the classification work and investigation work.

Methods of adjusting the range where the classification symbol is assigned according to the similar search information include a method of clustering the similar search information according to the similar search information to adjust the range where the classification symbol is assigned, and a method of learning the classification result to perform predictive classification. The method of clustering the similar search information according to the similar search information to adjust the range where the classification symbol is assigned may be, for example, a case of assigning a common classification symbol to an original document, a reply document of the original document, and a reply document of the reply document of the original document, in view of the common characteristics of meta-data. The method of learning the classification result to perform predictive classification learns so as to integrate the similar pieces of search information with respect to the classification result, thereby assigning the similar search information the identical or similar classification symbol.

In another example of the embodiment of the present invention, the reliability of the analysis result changes according to the number of documents that are to be targets of analysis. A statistical method may be applied to all the number of documents that are to be the targets of classification, thereby determining the time point and the ratio to all the documents for adjusting the range where the classification symbol is assigned on the basis of the analysis result.

In another example of the embodiment of the present invention, the range of documents where the classification symbol is assigned may be adjusted by executing both of the method of clustering search information according to the similar search information to adjust the range where the classification symbol is assigned, and the method of learning the classification result to perform predictive classification, as the method of adjusting the range where the classification symbol is assigned, according to the similar search information.

A document investigation report system and a document investigation report method and a document investigation report program according to other examples of the embodiment of the present invention create a report on the basis of the results of the classification work and investigation.

Consequently, the document investigation report system and the document investigation report method and the document investigation report program according to the other examples of the embodiment of the present invention can swiftly create an appropriate investigation report, and reduce the burden owing to classification work and report creating work.

The other example of the embodiment of the present invention can include a display screen controller that controls a display screen for presenting, to the user, the type of information extracted by the investigation type determiner.

The other example of the embodiment of the present invention can include an input accepting unit that accepts an input of a keyword and/or text by the user in conformity with the type of information presented by the display screen controller.

A document analysis program of the present invention is a document analysis program that obtains information recorded in a predetermined computer or server, and analyzes document information including multiple documents included in the obtained information, causing a computer to achieve an identification function of referring to an investigation basis database that stores a generation process model of occurrence of a predetermined action to be a cause of a litigation or fraud investigation, for each of phases to be classified according to development of the predetermined action, stores information related to the litigation or fraud investigation, for each of categories to which the litigation or fraud investigation belongs and the generation process model, and further stores time series information representing temporal order of the phases, and relationship between people related to the litigation or fraud investigation, and of analyzing the document information, based on information related to the litigation or fraud investigation, the generation process model, the time series information, and the relationship between people, to identify a current phase.

The identifying function can be implemented by the identifying section. The details are as described above.

The embodiment of the present invention accepts an input from a user on a category of a litigation case or fraud investigation case, thereby automatically updating the database according to the category. Consequently, a burden of clerical work of inputting the names of a person in charge and a custodian and the like is reduced. Search words are adjusted according to the database automatically updated according to categories, a classification symbol is automatically assigned to the document information using the adjusted search word. Consequently, the burden of classification work for the document information used for a litigation or fraud investigation case is reduced.

That is, the present invention facilitates analysis of the document information used for a litigation.

The control blocks of the document analysis system 1 may be implemented by logic circuits (hardware) formed on an integrated circuit (IC chip) and the like or software through use of CPU (Central Processing Unit). In the latter case, the document analysis system 1 includes a CPU that executes instructions of a program (control program) that are software implementing each function, ROM (Read Only Memory) or a storage device (which is called a “recording medium”) where the program and various data items are recorded in a manner readable by a computer (or CPU), and RAM (Random Access Memory) where the program is deployed. The computer (or CPU) reads the program from the recording medium and executes the program, thereby achieving the object of the present invention. The recording medium may be a “non-transitory, tangible medium”, for example, a tape, a disk, a card, a semiconductor memory, a programmable logic circuit, etc. The program may be supplied to the computer via any transmission medium (communication network, broadcast waves, etc.) that can transmit the program. The present invention can be achieved in a form of a data signal embedded in carrier waves implemented through electronic transmission of the program.

The present invention is not limited to each of the embodiments, and can be variously changed within a range represented by the claims. Embodiments obtained by appropriately combining pieces of technical means disclosed in different embodiments are also included in the technical scope of the present invention. Furthermore, combination of pieces of technical means disclosed in the embodiments can form new technical characteristics.

A document analysis system that obtains digital information recorded in computers or servers, analyzes document information including multiple documents included in the obtained digital information, and facilitates use for a litigation or fraud investigation, including: an investigation basis database that stores information related to the litigation or fraud investigation; an investigation category input accepting unit that accepts an input of a category of the litigation or fraud investigation; and an investigation type determiner that determines an investigation category that is a target of investigation, based on the category accepted by the investigation category input accepting unit, and extracts a required type of information from the investigation basis database.

The document analysis system further includes a display screen controller that controls a display screen for presenting, to the user, the type of information extracted by the investigation type determiner.

The document analysis system further includes an input accepting unit that accepts an input of a keyword and/or text by the user in conformity with the type of information presented by the display screen controller.

The document analysis system further includes an information extractor that extracts from the investigation basis database a keyword and/or text according to a type of the information extracted by the investigation type determiner.

The document analysis system further includes a searcher that searches the documents for the keyword and/or text.

The document analysis system further includes an automatic classification symbol assigner that automatically assigns the classification symbol to the document, wherein the keyword and/or text are used to assign the classification symbol.

A document analysis method that obtains digital information recorded in computers or servers, analyzes document information including multiple documents included in the obtained digital information, and facilitates use for a litigation or fraud investigation, including: an investigation category input accepting step of accepting an input of a category of the litigation or fraud investigation; and an investigation type determining step of determining an investigation category that is a target of investigation, based on the category accepted by the investigation category input accepting step, and extracting a required type of information from the investigation basis database that stores information related to the litigation or fraud investigation.

A document analysis program that obtains digital information recorded in computers or servers, analyzes document information including multiple documents included in the obtained digital information, and facilitates use for a litigation or fraud investigation, causing a computer to achieve: an investigation category input accepting function of accepting an input of a category of the litigation or fraud investigation; and an investigation type determining function of determining an investigation category that is a target of investigation, based on the category accepted by the investigation category input accepting function, and extracting a required type of information from the investigation basis database that stores information related to the litigation or fraud investigation.

### REFERENCE SIGNS LIST

1 Document analysis system
201 First automatic classifier
301 Second automatic classifier
401 Third automatic classifier
501 Quality inspector
601 Learning unit
701 Report creator
100 Data storage
101 Digital information storing area
103 Investigation basis database
104 Keyword database
105 Related term database
106 Score calculation database
107 Report creation database
109 Database manager
116 Score calculator
118 Document analyzer
120 Language determiner
122 Translator
124 Tendency information generator
130 Document display unit
131 Classification symbol accepting and assigning unit
133 Attorney review accepting unit
11 Document display screen
20 Investigation category input accepting unit
22 Investigation type determiner
24 Information extractor
26 Analyzer
28 Identifying section
30 Searcher
32 Automatic classification symbol assigner

1. A document analysis system that obtains information recorded in a predetermined computer or server, and analyzes document information including multiple documents included in the obtained information, comprising:
an investigation basis database that stores a generation process model of occurrence of a predetermined action to be a cause of a litigation or fraud investigation, for each of phases classified according to development of the predetermined action, stores information related to the litigation or fraud investigation, for each of categories to which the litigation or fraud investigation belongs and the generation process model, and further stores time series information representing temporal order of the phases, and a relationship between people related to the litigation or fraud investigation; and
an identifying section that analyzes the document information, based on the information related to the litigation or fraud investigation, the generation process model, the time series information, and the relationship between people, and identifies a current phase.

2. The document analysis system according to claim 1, wherein the relationship between people is obtained by analyzing content of communication data or domain information that is transmitted and received between terminals and is associated with each of the people and evaluating the relationship between the content of the communication data or domain information and the information related to the litigation or fraud investigation using a result of the analysis.

3. The document analysis system according to claim 2, further comprising:
an investigation category input accepting unit that accepts input of a category of the litigation or fraud investigation; and
an investigation type determiner that determines an investigation category that is a target of an investigation, based on the category accepted by the investigation category input accepting unit, and extracts a required type of information from the investigation basis database.

4-8. (canceled)

9. The document analysis system according to claim 1, further comprising an information extractor that extracts a keyword and/or text included in the document information, as information related to the litigation or fraud investigation, from the document information.

10. The document analysis system according to claim 2, further comprising an information extractor that extracts a keyword and/or text included in the document information, as information related to the litigation or fraud investigation, from the document information.

11. The document analysis system according to claim 3, further comprising an information extractor that extracts a keyword and/or text included in the document information, as information related to the litigation or fraud investigation, from the document information.

12. The document analysis system according to claim 9, further comprising a searcher that searches the multiple documents for the keyword and/or text.

13. The document analysis system according to claim 10, further comprising a searcher that searches the multiple documents for the keyword and/or text.

14. The document analysis system according to claim 11, further comprising a searcher that searches the multiple documents for the keyword and/or text.

15. The document analysis system according to claim 9, further comprising an automatic classification symbol assigner that automatically assigns a classification symbol to each of the multiple documents,
wherein the keyword and/or text is used to assign the classification symbol.

16. The document analysis system according to claim 10, further comprising an automatic classification symbol assigner that automatically assigns a classification symbol to each of the multiple documents,
wherein the keyword and/or text is used to assign the classification symbol.

17. The document analysis system according to claim 11, further comprising an automatic classification symbol assigner that automatically assigns a classification symbol to each of the multiple documents,
wherein the keyword and/or text is used to assign the classification symbol.

18. The document analysis system according to claim 12, further comprising an automatic classification symbol assigner that automatically assigns a classification symbol to each of the multiple documents,
wherein the keyword and/or text is used to assign the classification symbol.

19. The document analysis system according to claim 13, further comprising an automatic classification symbol assigner that automatically assigns a classification symbol to each of the multiple documents,
wherein the keyword and/or text is used to assign the classification symbol.

20. The document analysis system according to claim 14, further comprising an automatic classification symbol assigner that automatically assigns a classification symbol to each of the multiple documents,
wherein the keyword and/or text is used to assign the classification symbol.

21. A document analysis method that obtains information recorded in a predetermined computer or server, and analyzes document information including multiple documents included in the obtained information, comprising:
an identification step of referring to an investigation basis database that stores a generation process model of occurrence of a predetermined action to be a cause of a litigation or fraud investigation, for each of phases classified according to development of the predetermined action, stores information related to the litigation or fraud investigation, for each of categories to which the litigation or fraud investigation belongs and the generation process model, and further stores time series information representing temporal order of the phases, and a relationship between people related to the litigation or fraud investigation, and of analyzing the document information, based on information related to the litigation or fraud investigation, the generation process model, the time series information, and the relationship between people, to identify a current phase.

22. A document analysis program that obtains information recorded in a predetermined computer or server, and analyzes document information including multiple documents included in the obtained information, causing a computer to achieve
an identification function of referring to an investigation basis database that stores a generation process model of occurrence of a predetermined action to be a cause of a litigation or fraud investigation, for each of phases classified according to development of the predetermined action, stores information related to the litigation or fraud investigation, for each of categories to which the litigation or fraud investigation belongs and the generation process model, and further stores time series information representing temporal order of the phases, and a relationship between people related to the litigation or fraud investigation, and of analyzing the document information, based on information related to the litigation or fraud investigation, the generation process model, the time series information, and the relationship between people, to identify a current phase.
